(19) United States
(12) Patent Application Publication
(10) Pub. No.: US 2008/0280250 A1
(43) Pub. Date: Nov. 13, 2008

(54) Facial plane relator

(76) Inventor: Phillip P. Ho, Santa Barbara, CA (US)

Correspondence Address: COOPER & DUNHAM, LLP, 1185 AVENUE OF THE AMERICAS, NEW YORK, NY, 10036, US

(21) Appl. No.: 11/800,548

(22) Filed: May 7, 2007

(51) Int. Cl. A61C 19/04

(52) U.S. Cl. 433/73

(57) ABSTRACT

A facial plane relator has an arch, a horizontal plane and a vertical plane. The arch has an outer edge with a protrusion having two ends, an outer edge, a through hole and a clamp. The through hole is defined transversely through the ends of the protrusion. The clamp is mounted on the outer edge of the protrusion. The horizontal plane is mounted longitudinally in the through hole and has a front, a rear and two horizontal openings defined through the horizontal plane from the front to the rear. The vertical plane is clamped by the clamp of the arch, allows the vertical plane to be perpendicular to the horizontal plane and has a front, a rear and two vertical openings defined through the vertical plane from the front to the rear. The facial plane relator is aligned conveniently and accurately with patient's face through the vertical and horizontal openings.

### BACKGROUND OF THE INVENTION

1. Field of Invention

The present invention relates to a facial plane relator, and more particularly to a facial plane relator that allows an operational staff to align conveniently and accurately the facial plane with a patient's face for manufacturing a symmetrical and esthetic denture.

2. Description of the Related Art

As prosthodontic technique proceeds, an edentulous patient not only wants to have a practical denture, but also wants the denture natural and esthetic. Therefore, when the operational staff make a model for the patient, they must have the model relative to patient's face to make sure that the patient will smile with neat denture symmetrical with patient's face.

With reference to FIG. 6, a conventional facial plane relator has an arch (21), a horizontal plane (24) and a vertical plane (25).

The arch (21) has an outer edge and an inner edge. The outer edge of the arch (21) has a central part and a protrusion (22). The protrusion (22) protrudes from the central part of the outer edge of the arch (21) and has two ends, an outer edge, a through hole and a clamp (221). The outer edge of the protrusion (22) is formed on the protrusion (22) opposite to the outer edge of the arch (21). The through hole is defined transversely through the ends of the protrusion (22). The clamp (221) is U shaped and is mounted on the outer edge of the protrusion (22). The inner edge of the arch (21) has multiple fingers (23). The fingers (23) protrude from the inner edge of the arch (21) and are arranged on the inner edge of the arch (21) at intervals.

The horizontal plane (24) is mounted longitudinally through the through hole of the arch (21).

The vertical plane (25) is clamped by the clamp (221) of the arch (21) and allows the vertical plane (25) to be perpendicular to the horizontal plane (24).

In prosthodontic treatment, the operational staff first coats a silicone or wax over patient's teeth to make a model and draws vertical and horizontal lines respectively on patient's nose, chin and cheeks with an erasable marking pen. The operational staff coats the silicone or wax over the fingers (23) of the arch (21), aligns the vertical plane (25) with the vertical lines or directly with the nose without the vertical lines and aligns the horizontal plane (24) with the horizontal lines or directly with the lips without the horizontal lines. After the facial plane relator is aligned, the arch (21) is held to contact the silicone or wax in front of the patient's teeth for a few seconds to wait the silicone or wax to cure, so that the facial plane relator can be connected to and fastened on the model. Finally, the operational staff takes off the model with the facial plane relator and manufactures the denture according to the model. Thus, the operational staff can make sure that the denture will be symmetric with patient's face.

However, the horizontal plane (24) and the vertical plane (25) will shelter the lines on patient's face. The operational staff may have to move the facial plane relator to see the lines on patient's face, so it is inconvenient for the operational staff to align the facial plane relator and the facial plane relator may even not be aligned accurately with patient's face.

To overcome the shortcomings, the present invention provides a facial plane relator to mitigate or obviate the aforementioned.

### SUMMARY OF THE INVENTION

The primary objective of the present invention is to provide a facial plane relator that allows an operational staff to align conveniently and accurately the facial plane with a patient's face for manufacturing a symmetrical and esthetic denture.

To achieve the objective, the facial plane relator in accordance with the present invention has an arch, a horizontal plane and a vertical plane. The arch has an outer edge. The outer edge of the arch has a central part and a protrusion. The protrusion protrudes from the central part of the outer edge of the arch and has two ends, an outer edge, a through hole and a clamp. The outer edge is formed on the protrusion opposite to the outer edge of the arch. The through hole is defined transversely through the ends of the protrusion. The clamp is mounted on the outer edge of the protrusion. The horizontal plane is mounted longitudinally through the through hole of the arch and has a front, a rear and two horizontal openings. Each horizontal opening is defined through the horizontal plane from the front to the rear. The vertical plane is clamped by the clamp of the arch, allows the vertical plane to be perpendicular to the horizontal plane and has a front, a rear and two vertical openings. Each vertical opening is defined through the vertical plane from the front to the rear.

Therefore, the operational staff can align conveniently and accurately the facial plane relator with patient's face through the vertical and horizontal openings without moving the facial plane relator.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a facial plane relator in accordance with the present invention;

FIG. 2 is a top view of the facial plane relator in FIG. 1;

FIG. 3 is an exploded perspective view of the facial plane relator in FIG. 1;

FIG. 4 is a front view of the facial plane relator in FIG. 1;

FIG. 5 is an operational front view of the facial plane relator in FIG. 1; and

FIG. 6 is a perspective view of a conventional facial plane relator in accordance with the prior art.

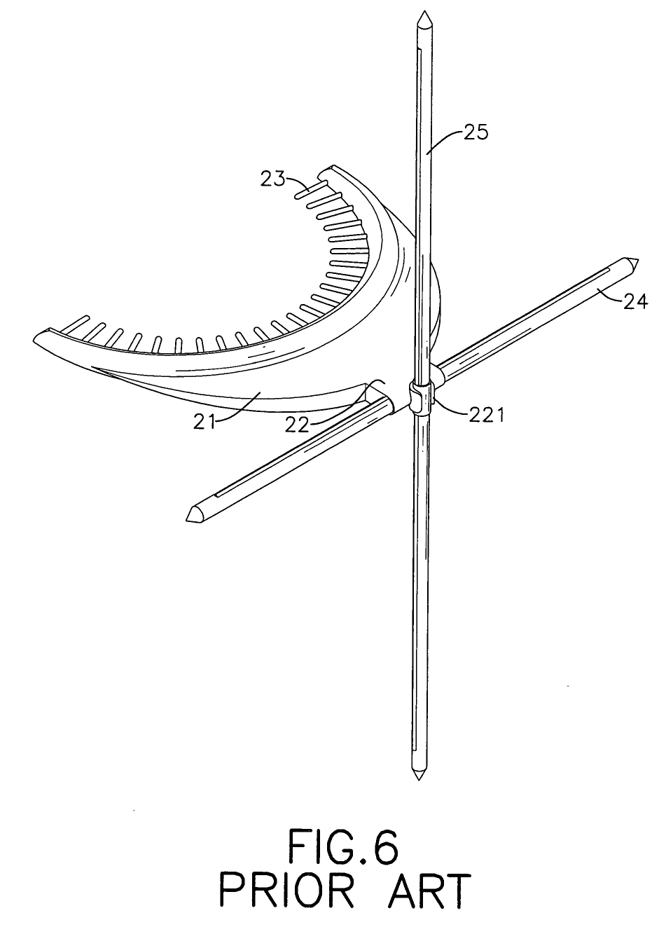

### DETAILED DESCRIPTION OF THE INVENTION

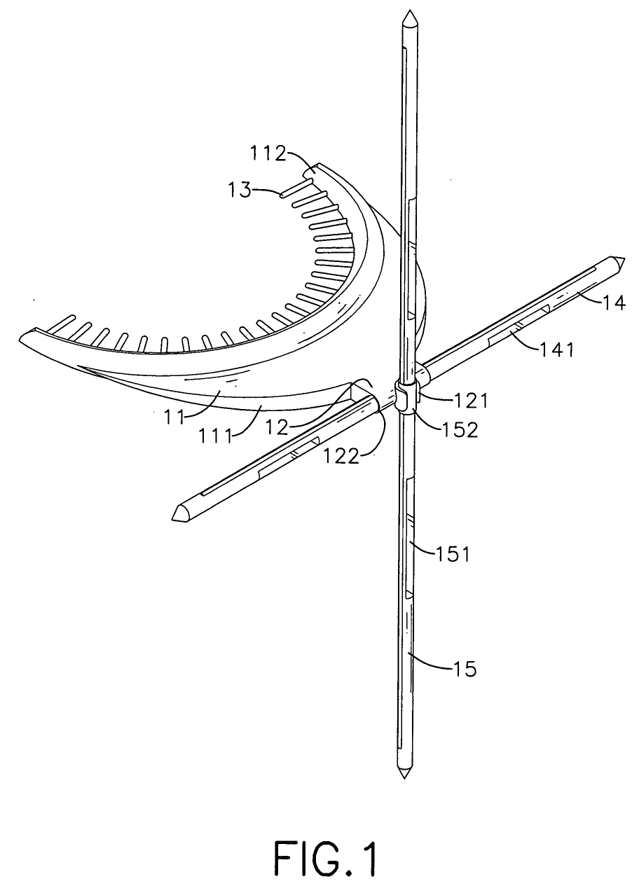

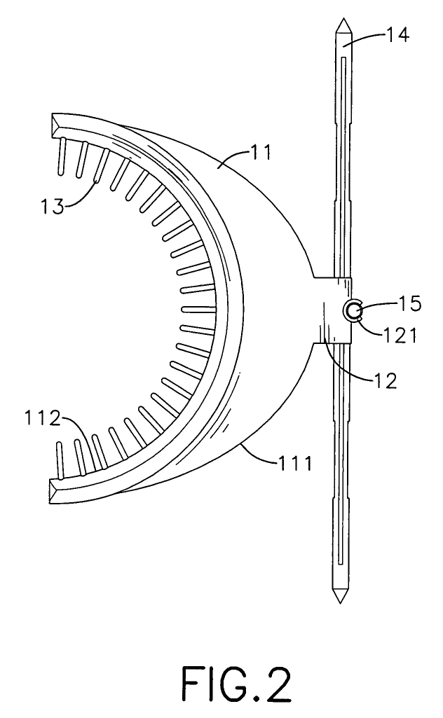

With reference to FIGS. 1 and 2, a facial plane relator in accordance with the present invention has an arch (11), a horizontal plane (14) and a vertical plane (15).

The arch (11) has an outer edge (111) and an inner edge (112). The outer edge (111) of the arch (11) has a central part and a protrusion (12). The protrusion (12) protrudes from the central part of the outer edge (111) of the arch (11) and has two ends, an outer edge, a through hole (122) and a clamp (121). The outer edge of the protrusion (12) is opposite to the outer edge (111) of the arch (11). The through hole (122) is defined transversely through the ends of the protrusion (12). The clamp (121) may be U shaped and is mounted on the outer edge of the protrusion (12). The inner edge (112) of the arch (11) has twenty-five fingers (13). The fingers (13) protrude from the inner edge (112) of the arch (11) and are arranged on the inner edge of the arch (11) at intervals.

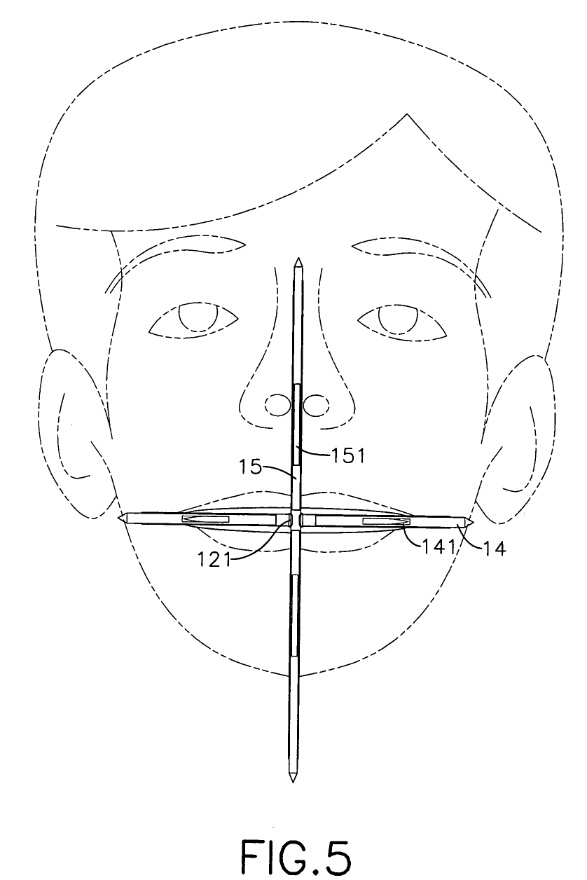

With further reference to FIG. 5, the horizontal plane (14) is mounted longitudinally through the through hole (122) of the arch (11) and has a front, a rear, two ends, a central segment and two horizontal openings (141). The central segment is mounted transversely in the through hole (122) of the arch (11) and allows the horizontal plane (14) to be mounted symmetrically with the arch (11). Each horizontal opening (141) is defined through the horizontal plane (14) from the front to the rear and is located between the central segment and one of the ends. Thus, an operational staff can directly see lines on a patient's cheek through the horizontal opening (141) to align the horizontal plane (14) with the lines.

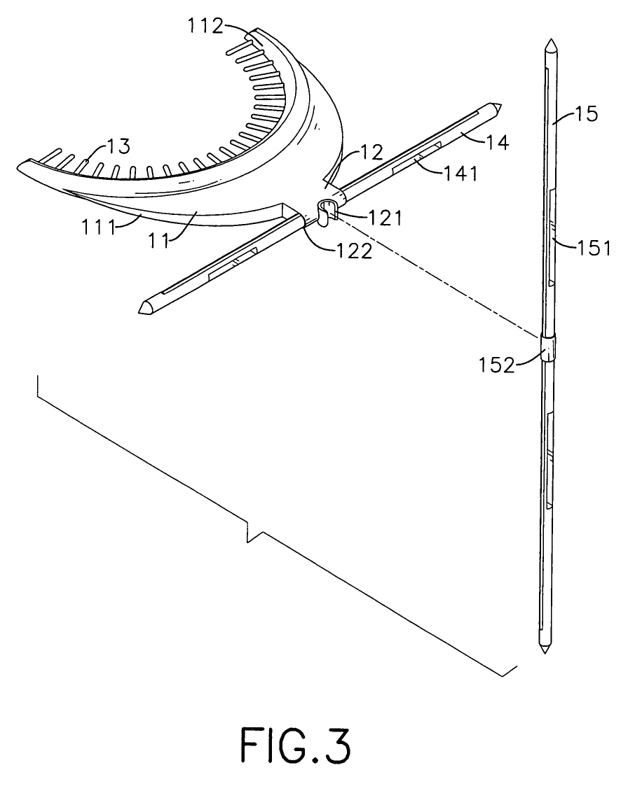

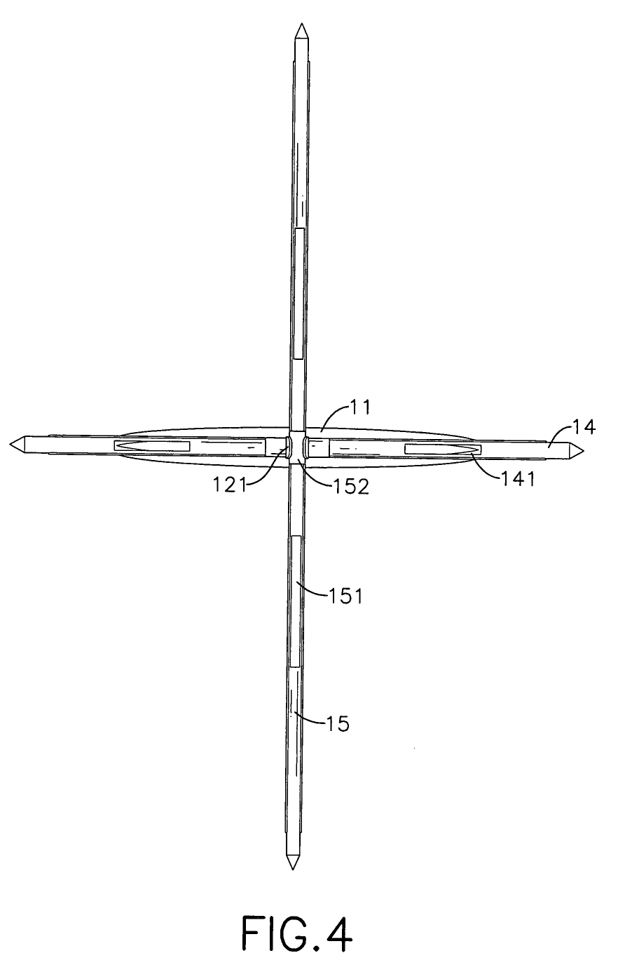

With further reference to FIGS. 3 and 4, the vertical plane (15) is clamped by the clamp (121) of the arch (11), allows the vertical plane (15) to be perpendicular to the horizontal plane (14) and has a front, a rear, two ends, a central segment and two vertical openings (151). The central segment is clamped by the clamp (121) of the arch (11), allows the vertical plane (15) to be mounted symmetrically with the arch (11) and has a skidproof sleeve (152). The skidproof sleeve (152) surrounds the central segment of the vertical plane (15) to allow the clamp (121) to clamp securely the vertical plane (15). Each vertical opening (151) is defined through the vertical plane (15) from the front to the rear and is located between the central segment and one of the ends. Thus, the operational staff can see directly lines on a patient's nose and chin through the vertical opening (151) to align the vertical plane (15) with the lines.

Therefore, the operational staff can align conveniently and accurately the facial plane relator with patient's face through the vertical and horizontal openings (151) (141) without moving the facial plane relator. Additionally, a denture that is manufactured according to a model with the facial plane relator of the present invention will be exactly symmetrical and esthetic.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A facial plane relator comprising:
an arch having
an outer edge having
a central part; and
a protrusion protruding from the central part of the outer edge of the arch and having
two ends;
an outer edge formed on the protrusion opposite to the outer edge of the arch;
a through hole defined transversely through the ends of the protrusion; and
a clamp mounted on the outer edge of the protrusion; and
a horizontal plane mounted transversely through the through hole of the arch and having
a front;
a rear; and
two horizontal openings and each horizontal opening defined through the horizontal plane from the front to the rear;
a vertical plane clamped by the clamp of the arch, being perpendicular to the horizontal plane and having
a front;
a rear; and
two vertical openings and each vertical opening defined through the vertical plane from the front to the rear.

2. The facial plane relator as claimed in claim 1, wherein the clamp is U shaped.

3. The facial plane relator as claimed in claim 1, wherein the arch further has an inner edge with twenty-five fingers protruding from the inner edge of the arch and arranged on the inner edge of the arch at intervals.

4. The facial plane relator as claimed in claim 1, wherein
the horizontal plane further has
two ends;
a central segment mounted longitudinally in the through hole of the arch and keeping the horizontal plane mounted symmetrically with the arch; and
each horizontal opening located between the central segment and one of the ends; and
the vertical plane further has
a central segment clamped by the clamp of the arch and keeping the vertical plane mounted symmetrically with the arch; and
each vertical opening located between the central segment and one of the ends.

5. The facial plane relator as claimed in claim 1, wherein the central segment of the vertical plane has a skidproof sleeve surrounding the central segment of the vertical plane and keeping the clamp clamping securely the vertical plane.
